(19) United States
(12) Patent Application Publication
(10) Pub. No.: US 2007/0252389 A1
(43) Pub. Date: Nov. 1, 2007

(54) Duct Coupling Assembly

(75) Inventors: Mark Milici, Kinnelon, NJ (US); Erich Aigner, Davis, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: DYWIDAG-SYSTEMS INTERNATIONAL, Bolingbrook, IL (US)

(21) Appl. No.: 11/380,603

(22) Filed: Apr. 27, 2006

(51) Int. Cl. F16L 21/02

(52) U.S. Cl. 285/369

(57) ABSTRACT

An assembly for joining ribbed ducts together includes a sleeve having a first section and a second section both sized to receive an end portion of one of the ducts, a pair of bushings, with each bushing sized to fit over the end portion of a corresponding one of the ducts and sized to engage a circumferential rib of the corresponding duct, a pair of seals, with each seal sized to fit within the sleeve and over the end of a corresponding one of the ducts, and a recess disposed adjacent each of the first end and the second end of the sleeve, with each recess sized to snap fit into the sleeve or to receive a tie, to enable the first end and the second end of the sleeve to be secured to the first and second ducts, respectively.

### FIELD OF THE INVENTION

The present invention relates to corrugated plastic ducts used in post tension applications, and more particularly to an assembly for coupling together adjacent sections of corrugated plastic ducts, and/or to an assembly for coupling corrugated plastic ducts to related anchorage transitions or trumpets.

### BACKGROUND OF THE INVENTION

A reinforced concrete structure such as a bridge, a high rise building, or other structure typically has high strength steel tendons placed in the concrete in order to strengthen the structure. These tendons may be single bars or multiple bars or strands. In many applications, federal, state, or local building codes or other regulations require encapsulation of the reinforcing steel within an air tight duct. Consequently, many concrete contractors typically use various forms of commercially available corrugated plastic ducts in concrete construction.

In many structures, such as long bridges, contractors must use multiple duct sections, as each individual duct section is not long enough to extend the entire length of the concrete structure being formed. Consequently, contractors must form a joint or other connection between adjacent sections of the duct. Ideally, the contractor forms the joint so as to minimize the chances that air, moisture, or other contaminants will be able to enter the duct and ultimately corrode or oxidize the reinforcing steel. Contractors also must form a joint or other connection where the duct transitions to an anchor secured adjacent an end of the structure being formed. Typically, these anchor connections involve the use of a trumpet fitting secured to a cast anchor, and the connection joins the duct to the end of the trumpet fitting.

At least one prior art coupling method for joining adjacent duct sections together uses an external slip coupler that surrounds the outer ends of a pair of adjacent ducts. A heat shrink sleeve is applied over the coupler to make the joint air tight. However, the use of heat shrink sleeves is time consuming in the field where labor rates can have a profound impact on the cost of installation. Also, because this method requires heat, contractors must bring a heat gun, torch, or other heat source into the field. Further, the heat shrink method typically requires that the installer have 360 degree access around the circumference of the assembly. Unfortunately, it is often difficult for contractors to gain 360 degree access to the joint. Finally, in some circumstances the heat applied may damage the plastic duct if particular care is not taken.

### SUMMARY OF THE DISCLOSURE

In accordance with an aspect of the invention, a duct assembly comprises a first duct and a second duct having a plurality of circumferential ribs intermittently spaced along the longitudinal axis, a sleeve having a first section and a second section, with the first section sized to receive an end portion of the first duct and the second section sized to receive an end portion of the second duct, a pair of bushings each sized to fit over the end portion of a corresponding one of the first and second ducts and each further sized to engage at least a first rib of the corresponding duct and to extend into a corresponding one of the first and second sections of the sleeve, a pair of seals sized to fit within the sleeve and over one of the end portions of a corresponding one of the first and second ducts, and an annular recess disposed adjacent each of the first end and the second end of the sleeve and sized to engage a portion of the corresponding bushing to thereby secure the corresponding ducts in the sleeve.

In accordance with another aspect of the invention, an assembly for coupling a duct to a fitting comprises a bushing sized to fit over the duct and to extend into a flared end of the fitting, with the bushing having an internal recess sized to engage a first circumferential rib of the duct, the bushing having an external recess, a seal sized to fit within the fitting and over the duct, with the external recess of the bushing sized and positioned to engage an inner portion of the flared end to secure the duct to the fitting.

In accordance with a further aspect of the invention, an assembly for coupling a duct to a post tension anchor transition or trumpet comprises a duct having a longitudinal axis and a plurality of circumferential ribs intermittently spaced along the longitudinal axis, a trumpet fitting having a first end adapted for attachment to the anchor and a flared second end and having a circumferential recess disposed adjacent the flared second end, a bushing, the bushing sized to fit over the duct and to extend into the flared end of the fitting, the bushing having an internal circumferential recess sized to engage a first one of the circumferential ribs, the bushing also including an external circumferential recess, a seal sized to fit within the fitting and over a second one of the circumferential ribs of the duct, and a tie sized to extend around the external recess of the fitting in a position to generally overlie the external recess of the bushing and adapted to secure the duct to the fitting.

### BRIEF DESCRIPTION OF THE DRAWINGS

FIG. 1 is an elevational view, partly in cutaway, of a duct coupling assembly in accordance with a first disclosed example of the present invention;

FIG. 2 is a perspective view of a bushing assembled in accordance with the teachings of the present invention and shown attached to a duct section;

FIG. 3 is an enlarged view in perspective of the bushing;

FIG. 4 is an enlarged fragmentary view taken along line 4-4 of FIG. 3 and showing the bushing of FIGS. 2 and 3 in place on a duct section;

FIG. 5 is an enlarged cross-sectional view taken along line 5-5 of FIG. 1;

FIG. 6 is an elevational view, partly in section, of a coupling sleeve for use with the assembly of FIG. 1;

FIG. 7 is an enlarged fragmentary cross-sectional view of one of the outer ends of the coupling sleeve illustrated in FIG. 6;

FIG. 8 is an elevational view of a seal for use with the assembly of FIG. 1;

FIG. 9 is a side view of the seal shown in FIG. 8;

FIG. 10 is an elevational view of a seal for use with the assembly of FIG. 12, and may be used as an alternate for the seal of FIGS. 8 and 9 in applications where the duct either includes or does not include longitudinal ribs;

FIG. 11 is a side view of the seal of FIG. 10;

FIG. 12 is an elevational view, partly in section, of another duct section in the form of a fitting for attachment to an anchor and having a widened or bell end receiving a duct section;

FIG. 13 is an elevational view, partly in section, of the fitting of FIG. 12 shown detached from the anchor;

FIG. 14 is an enlarged fragmentary cross-sectional view of the bell end of the fitting;

FIG. 15 is an enlarged fragmentary cross-sectional view of the other end of the fitting and illustrating how the other end is shaped for securement to the anchor;

FIG. 16 is perspective view illustrating a bushing assembled in accordance with the teachings of another disclosed example of the present invention and shown installed over a duct having a different circumferential rib arrangement and no longitudinal ribs;

FIG. 17 is perspective view illustrating a bushing assembled in accordance with the teachings of still another disclosed example of the present invention and shown installed over a duct having increased spacing between adjacent circumferential ribs;

FIG. 18 is a cross-sectional view of the duct of FIG. 16 coupled to a fitting similar to the fitting of FIG. 12.

### DETAILED DESCRIPTION OF THE DISCLOSED EXAMPLES

Although the following text sets forth a detailed description of exemplary embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, with those alternative embodiments still falling within the scope of the claims defining the invention.

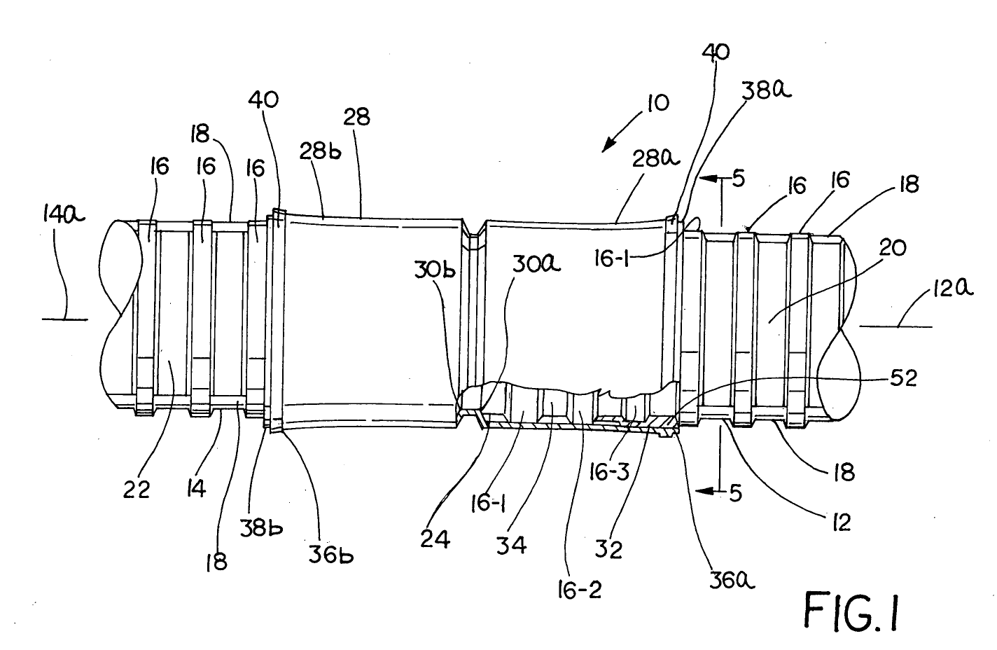

Referring now to the drawings, FIG. 1 illustrates a duct assembly 10 assembled in accordance with the teachings of the first disclosed example of the present invention. The duct assembly 10 is used to secure a first duct 12 to a second duct 14. In accordance with the disclosed example, each of the ducts 12 and 14 includes a longitudinal axis 12a and 14a, respectively. Further, in accordance with the disclosed example, each of the ducts 12 and 14 includes a plurality of circumferential ribs 16 spaced longitudinally along the ducts, and also includes one or more longitudinal ribs 18 extending generally parallel to the axes 12a and 14a. It will be appreciated that each of the ducts 12 and 14 has a generally circular cross-section and that, in the disclosed example, the ribs 16 and 18 are raised so as to extend generally radially outwardly from an outer surface 20, 22 of the ducts 12 and 14, respectively.

The duct 12 includes an end 24 while the duct 14 includes an end 26, and when the ducts 12 and 14 are positioned as shown in FIG. 1 the ends 24 and 26 extend into a coupling sleeve 28. Only the end 24 of the duct 12 is visible in the cutaway of FIG. 1, although it will be appreciated that the end 26 of the duct 14 is situated within the sleeve 28 in a similar manner, albeit from a different direction. The sleeve 28 includes a first section 28a disposed toward the right of FIG. 1 and a second section 28b disposed toward the left of FIG. 1, with an inwardly extending recess or groove 30 separating the first and second sections 28a and 28b. A bushing 32 and a seal 34 surround a portion of the duct 12 and are positioned within the first section 28a of the sleeve 28. Another bushing 32 and another seal 34 surround a portion of the duct 14 in a similar manner and are positioned within the second section 28b of the sleeve 28, although the bushing 32 and the seal 34 disposed within the second section 28b are not visible in FIG. 1.

The bushing 32 engages a circumferential rib 16-3, while the seal 34 sits in a space between circumferential ribs 16-1 and 16-2. Preferably, each of the bushings 32 includes an internal recess 32a. The internal recess 32a on the bushing 32 is sized to fit over the underlying circumferential rib, which in this case is the rib 16-3, with the internal recess 32a preferably sized to closely correspond to the outer contours of the underlying circumferential rib 16-3. The coupling sleeve 28 is preferably constructed of polypropylene or a mix of polyethylene and polypropylene. The bushing 32 is preferably constructed of a relatively hard plastic material, such as polyethylene, although other materials and other forms of plastic may prove suitable.

In the example of FIG. 1, the groove 30 extends inwardly into the interior of the coupling sleeve 28, and the end 24 of the first duct 12 is shown extending to a point adjacent to an interior surface 30a of the groove 30. The end 26 of the second duct 14 also is disposed adjacent an interior surface 30b of the groove 30 in a similar fashion, although this is not visible in FIG. 1. Depending on where the ducts 12 or 14 are cut, the ends 24 and 26 of the ducts 12 and 14, respectively, may be disposed closely adjacent to the interior surfaces 30a, 30b, or the ends 24 or 26 may abut the respective interior surfaces 30a or 30b.

Referring still to FIG. 1, the coupling sleeve 28 includes a recess 36a formed generally adjacent to an end 38a of the first section 28a of the coupling sleeve 28, and also includes a recess 36b formed generally adjacent to an end 38b of the coupling sleeve 28. In accordance with a preferred method of assembly, the ducts 12 and 14 preferably will snap into place within the coupling sleeve in a manner to be discussed in greater detail below. However, in an alternate method of assembly, a tie 40 (illustrated encircling the coupling sleeve 28 in FIG. 1) may be secured around the coupling sleeve 28 adjacent each end 38a and 38b of the coupling sleeve 28, with each tie 40 generally adjacent to or generally overlying a corresponding one of the recesses 36a and 36b. Preferably, each tie 40 is a nylon cable tie, although other types of ties may prove suitable. Although the snap in arrangement may be preferred, those of skill in the art may recognize that, in certain temperature situations, the coupling sleeve may be too stiff to deform enough to permit the snap in arrangement. In such a situation, the installer may have to snip the sleeve in one or more locations in order to insert the duct and the attached seal and bushing in place. The tie 40 can then be placed around the assembly in the manner discussed above.

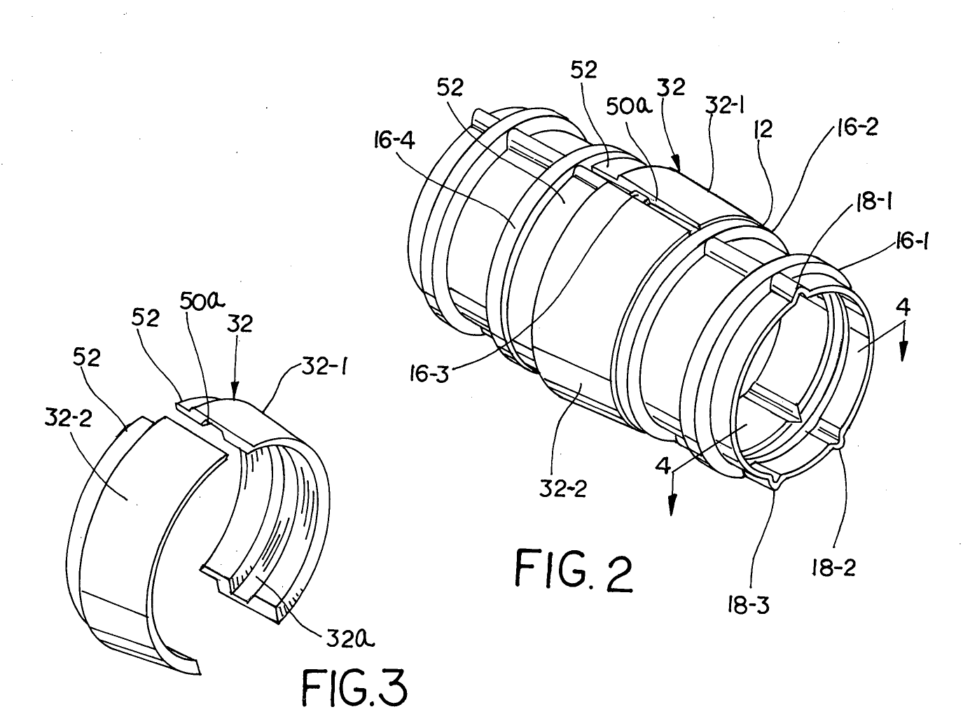

FIGS. 2 and 3 show a portion of the first duct 12 with the bushing 32 either installed on one of the ducts, such as the first duct 12 (FIG. 2), or separate from the duct (FIG. 3). As shown in FIG. 3, the bushing 32 is preferably constructed of two identical halves 32-1 and 32-1. For ease of reference, the following discussion will refer to the bushing 32 in the singular, but it will be understood that in the disclosed example the two pieces 32-1 and 32-2 will preferably be used, and that both bushing pieces 32-1 and 32-2 will preferably be identical.

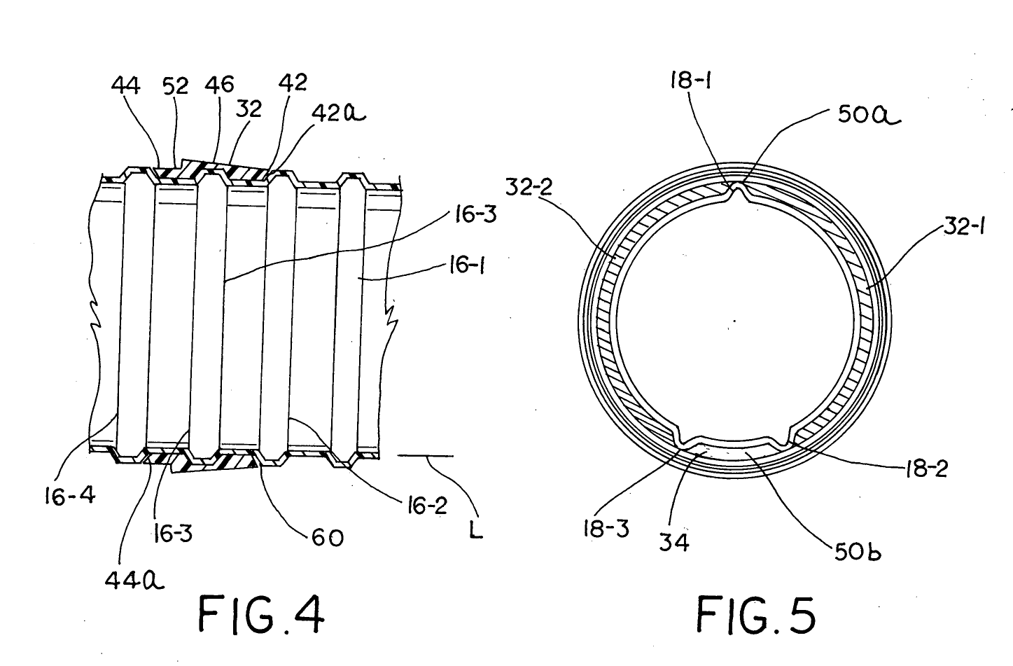

When the bushing 32 is disposed on the duct 12 as shown in FIGS. 2 and 4, the internal recess 32a of the bushing 32 is disposed directly over the circumferential rib 16-3 (this is also visible in FIG. 1). As best shown in FIGS. 2-4, the bushing 32 includes an inner end 42, an outer end 44, and a central section 46. As best shown in FIG. 4, the inner end 42 of the bushing 32 extends closely adjacent to or abuts the circumferential rib 16-2, while the outer end 44 extends closely adjacent to or abuts the circumferential rib 16-4. The internal recess 32a of the bushing fits over the circumferential rib 16-3. The bushing 32 includes an outer recess 52 disposed generally adjacent the outer end 44.

As shown in FIG. 5, in the exemplary ducts 12 and 14, three (3) longitudinal ribs 18 are shown and are numbered 18-1, 18-2, and 18-3. As is visible in FIG. 5, preferably the bushing pieces 32-1 and 32-2 are positioned about the duct 12 so as to form a slight gap 50a to provide clearance for the longitudinal rib 18-1, and a slightly larger gap 50b which is sized such that the ribs 18-2 and 18-3 fit within the gap 50b. A portion of the seal 34 is visible between the ribs 18-2 and 18-3.

Referring now FIG. 4, the bushing 32 is shown installed on either one of the first duct 12 or the second duct 14. Preferably, the bushing 32 is sized such that an outer portion 44 fills the space between the circumferential ribs 16-3 and 16-4, such that the outer end 44 extends all the way to the circumferential rib 16-4, with an angled face 44a of the bushing 32 abutting an angled surface on the circumferential rib 16-4. In accordance with the disclosed example, the angled face is sloped about 60 degrees relative to a reference line L. Preferably, the inner end 42 of the bushing 32 extends to the next adjacent circumferential rib 16-2. The inner end 42 preferably includes an angled face 42a which, in accordance with the disclosed example, slopes about 60 degrees relative to the reference line L. Preferably, the central section 46 of the bushing is slightly tapered, such that an outer surface of the bushing 32 slopes slightly from a point adjacent the recess 52 toward the inner end 42. In accordance with the disclosed example, the slope of the central section 46 is about 5 degrees, and more preferably about 5.2 degrees, relative to line L in FIG. 4.

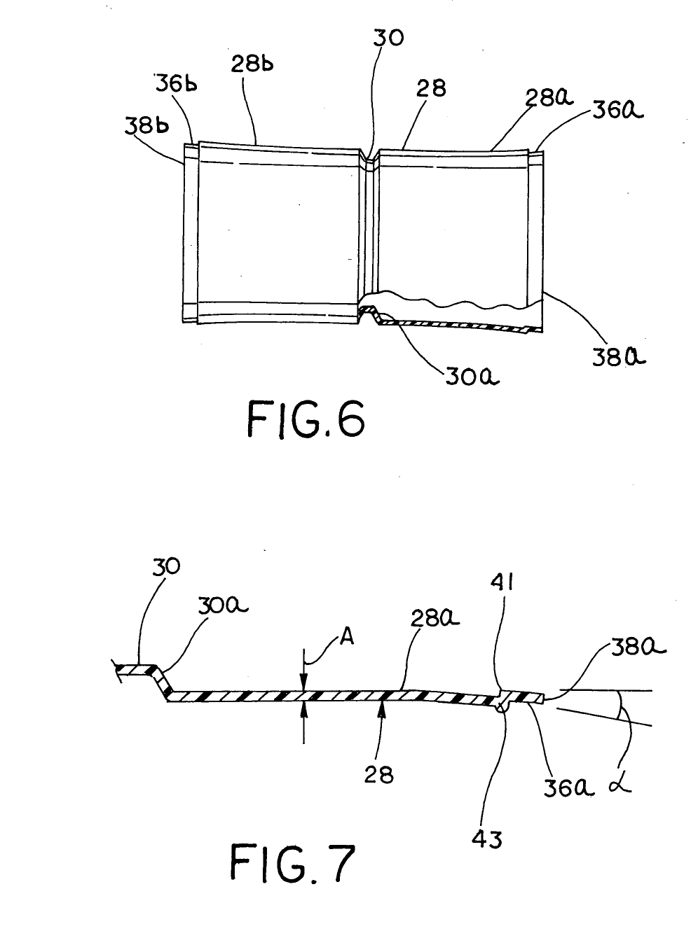

Referring now to FIGS. 6 and 7, the first section 28a of the coupling sleeve 28 is shown. In the disclosed example, the recess 36a is formed by an inward offset forming an inwardly extending annular lip 41. Preferably, a thickened section 43 is formed adjacent the inward offset. In accordance with the disclosed example, the coupling sleeve 28 may taper outwardly (downwardly when viewing FIG. 7) generally adjacent to outer end 38a at an angle of about 5°, and still preferably about 5.2°. Although only one section of the coupling sleeve 28 is shown, it will be appreciated that the opposite end of the coupling sleeve 28 is substantially identical.

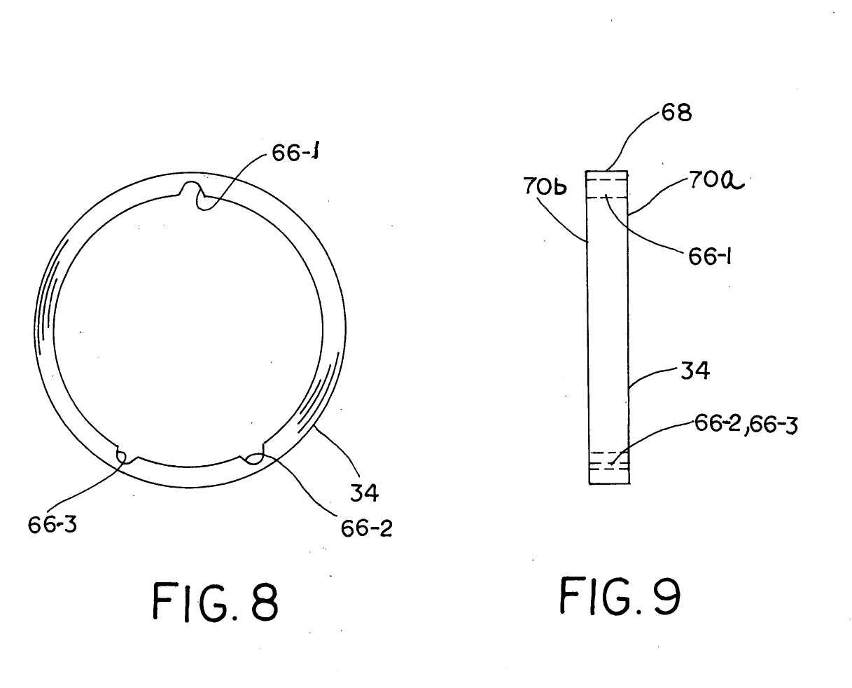

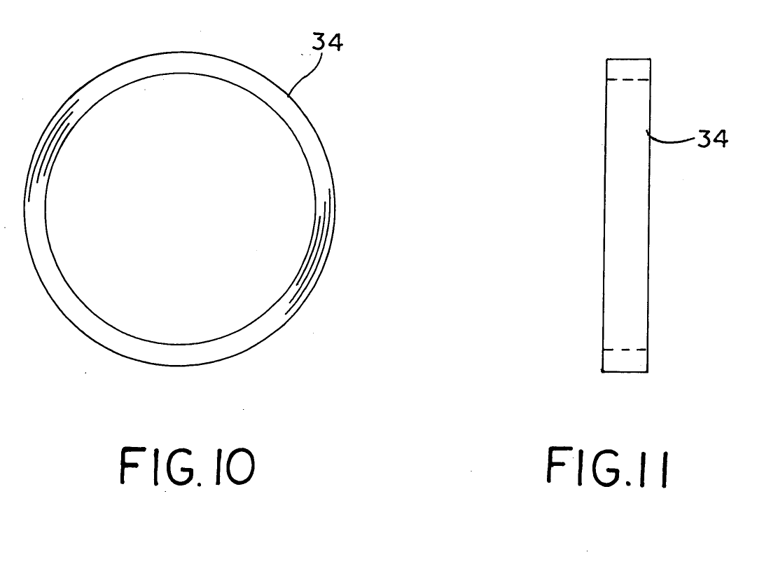

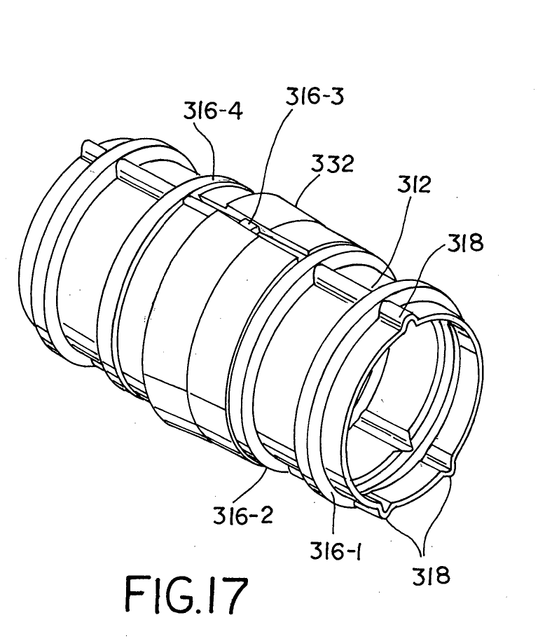

Referring now to FIGS. 8 and 9, the seal 34 is shown in greater detail. The seal 34, which is sized to surround either one of the ducts 12 or 14, includes a number of slots 66-1, 66-2, and 66-3, each of which is sized to fit over a corresponding one of the longitudinal ribs 18-1, 18-2, and 18-3, respectively. The seal 34 includes a central section 68 bounded by a pair of edges 70a and 70b. It will be appreciated that the slots 66-1, 66-2, and 66-3 extend between the edges 70a and 70b, such that a continuous portion of the central section 68 of the seal 32 encircles the relevant duct 12 or 14. It will also be appreciated that the seal 34 is constructed of a resilient or compressible material, such as closed cell ethylene propylene diene (EPDM) or neoprene. Other materials may prove suitable. One of skill in the art will appreciate that the slots 66-1, 2 and 3 may be sized to correspond to the contours of the ribs 18. FIGS. 10 and 11 illustrate a seal similar to the seal of FIGS. 8 and 9, but lacking cutouts to receive longitudinal ribs. The seal of FIGS. 10 and 11 may be used with, for example, the assembly of FIG. 16.

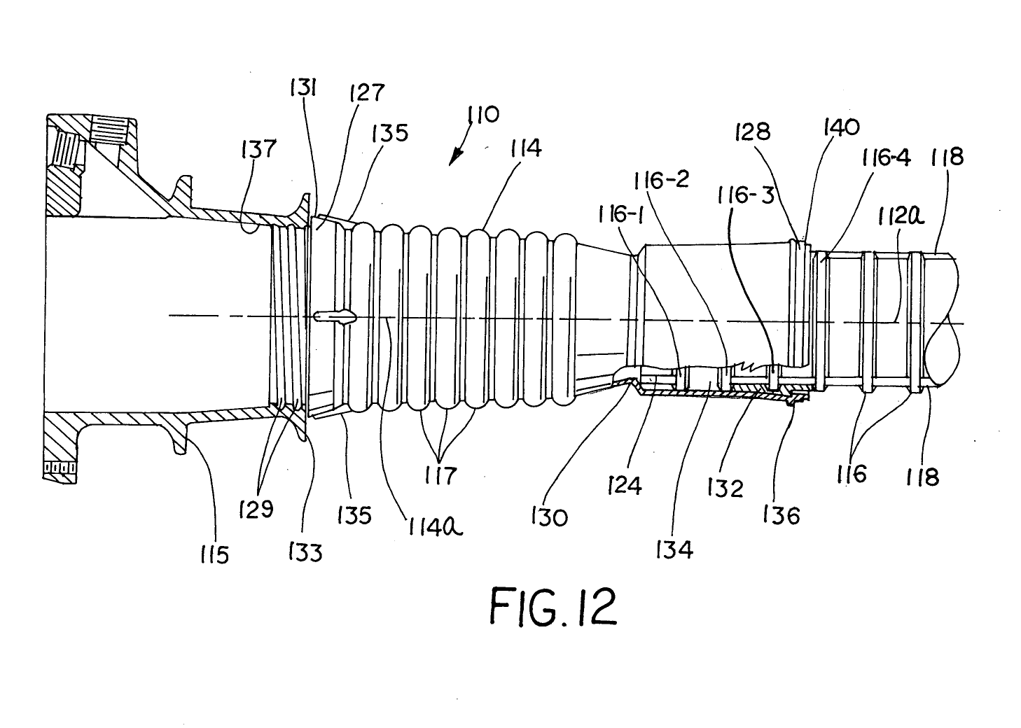

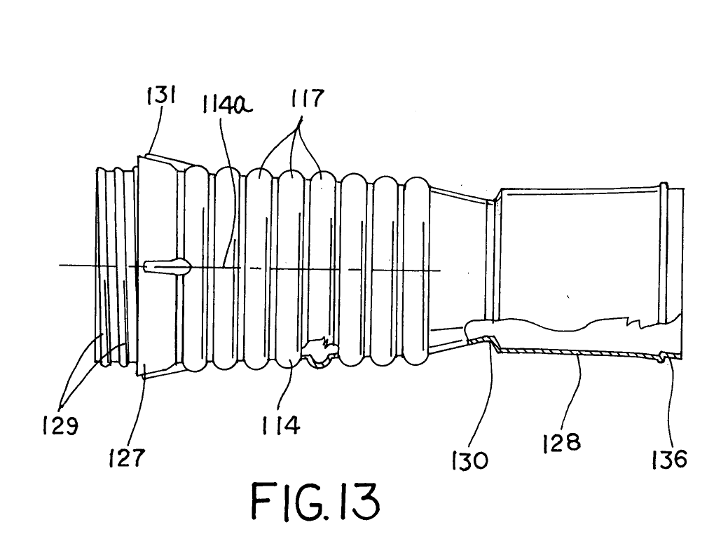

Referring now to FIG. 12, another disclosed example of a duct assembly 110 assembled in accordance with the teachings of the present invention is shown. The duct assembly 110 is used to secure a duct 112 to a fitting 114. The fitting 114, in turn, is connected to an anchor 115. Those of skill in the art will understand that the anchor 115 is typically bolted to a concrete form (not shown) in a conventional manner, and that the anchor will typically include a plurality of grouting ports.

The duct 112 and the fitting 114 include a longitudinal axis 112a and 114a, respectively. The duct 112 includes a plurality of circumferential ribs 16 spaced longitudinally along the ducts, and also includes one or more longitudinal ribs 18 extending generally parallel to the axis 112a. The duct 112 may be similar in all respects to the ducts 12 and 14 discussed above, and preferably has a generally circular cross-section. The fitting 114 includes a plurality of circumferential ribs 117.

The duct 112 includes an end 124, while the fitting 114 includes a widened or bell end 126, and another end 127 that connects to the anchor 115 as will be explained in greater detail below. When positioned as shown in FIG. 12, the end 124 extends into the bell end 126 of the fitting 114. The bell end 126 preferably is very similar to one of the end sections 28a or 28b of the coupling sleeve discussed above with respect to the first embodiment. The bell end 126 includes an end section 128 disposed toward the right of FIG. 12, and further includes an inwardly extending recess or groove 130 separating the bell end 126 from the central section of the fitting having the ribs 117. A bushing 132 and a seal 134 surround a portion of the duct 112 and are positioned within the end section 128 of the bell end 126. The bushing 132 and the seal 134 preferably are similar in all respects to the bushing 32 and seal 34 discussed above with respect to the first disclosed embodiment.

The bushing 132 engages a circumferential rib 116-3 on the duct 112, while the seal 134 sits between adjacent circumferential ribs 116-1 and 116-2 on the duct 112. In the example of FIGS. 12 and 13, the groove 130 extends inwardly into the interior of the fitting 114 far enough that the end 124 of the duct 112 abut an interior surface 130a of the groove 130. The bell end 126 includes a recess 136 formed generally adjacent to an end 138a of the first section 128 of the bell end 126. Preferably, the duct 112 will snap into the fitting 114 in a manner similar to the snap in arrangement mentioned above with respect to the first disclosed example. Alternatively, a tie 140 may be secured around the coupling sleeve 128 adjacent the end of the fitting 114, with the tie 140 generally adjacent to or generally overlying the recess 136. Again, the tie 140 may be a nylon cable tie, although other types of ties may prove suitable.

As outlined above, the end 127 of the fitting 114 is connected to the anchor 115. As shown in FIG. 15, the end 127 of the fitting 114 is preferably formed to include a series of threads 129 and a widened flange 131. The widened flange 131 is preferably sized and located so as to abut a flange 133 on the anchor 115. Preferably, the fitting 114 includes a number of stiffeners or gussets 135 formed adjacent the flange 131. Still preferably, the threads 129 are formed so as to thread into an aperture 137 on the anchor 115.

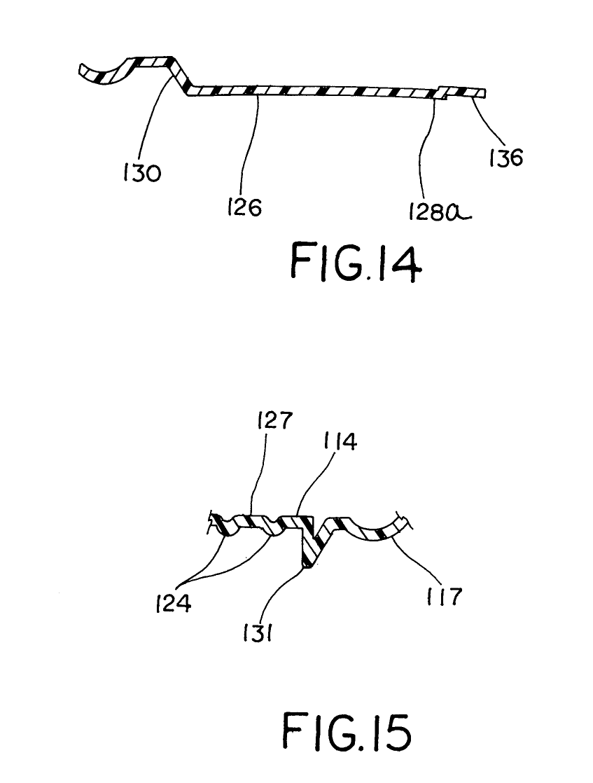

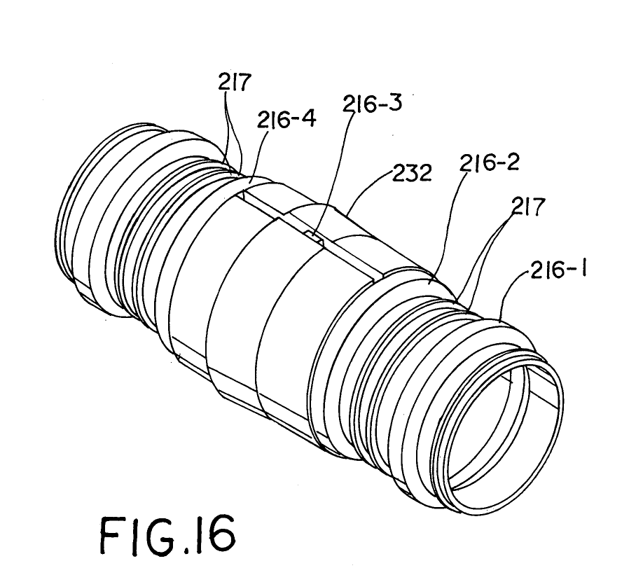

As shown in FIG. 14, the bell end 126 of the fitting 114 may be exactly the same as the end of the coupling sleeve 28 discussed above, except for the transition into the section of the fitting 114 having the ribs 117.

In operation, when assembling the duct system as shown in FIG. 1, the bushings 32 are placed on the respective ducts 12 or 14 by placing the bushing pieces 32-1 and 32-2 as shown in FIG. 2. The bushings 32 are positioned such that the recess 32a of each piece fits the proper circumferential rib 16-3. The seal 34 is installed by positioning the seal 34 between the proper circumferential ribs, in this case 16-1 and 16-2.

Referring still to FIG. 1, with the bushing 32 and the seal 34 attached, the duct 12 is pushed into the coupling sleeve 28 from the right toward the left when viewing the Figure. Because the bushing 32 is slightly tapered, and because the end 38a of the coupling sleeve 28 is flared outwardly slightly, the outer end of the coupling sleeve 28 will expand slightly in response to the insertion force. When the duct 12 is inserted far enough, the recess 36 passes annular lip 41, and the annular lip 41 snaps into the recess 36 on the bushing 34 as the outwardly deflected coupling sleeve 28 snaps back to its original or nearly original shape. Consequently, the seal 34 is compressed inside the coupling sleeve 28, and the duct 12 is secured in place within the coupling sleeve 28 by the mechanical interlock between the edge of the recess 36 and the annular lip 41 on the interior of the coupling sleeve 28. The other duct 14 may be assembled in a similar manner. Still further, the assembly of FIG. 12 may be assembled in a similar manner.

As mentioned above, preferably the bushing fits over the circumferential rib 16-3 on each of the ducts. The seals 34 are placed between the appropriate circumferential ribs, which in this case are the circumferential ribs 16-1 and 16-2. The rib 16-1 happens to be the rib closest to the end of the ducts and which is the rib disposed furthest into the coupling sleeve 28.

As mentioned above, alternatively the assembly may be assembled in a similar manner, but secured using the nylon tie 40. As also mentioned above, in certain circumstances the coupling sleeve 28 or the bell end of the fitting 115 may have to be snipped prior to assembly. Such circumstances may arise when cold temperatures make it difficult if not impossible for the coupling sleeve 28 or the bell end of the fitting 115 to deflect sufficiently outward in response to insertion of the appropriate duct. When the tie 40 is necessary, the tie 40 is positioned in the appropriate recess and cinched down until tight.

In accordance with the disclosed example, the bushing 32 strengthens the mechanical connection between the appropriate duct and the coupling sleeve 28. The bushing 32 also provides additional pullout protection. The additional mechanical strength provided by the bushing 32 helps to ensure that bending or other forces are not transferred through the seal 34, which in turn helps to ensure that the integrity of the seal between the appropriate duct and the coupling sleeve. The bushing 32 further serves to align the ducts at the connection point.

Preferably, the seal 34 is constructed of a resilient, compressible material. In practice, relatively soft 60 durometer neoprene has proven to be effective. The bushing 32 is preferably constructed of a hard plastic material, although other materials may prove suitable and still provide the desired pullout resistance and mechanical strength at the connection point. In the example shown, both the bushing 32 and the seal 34 are sized and shaped to generally correspond to the outer contours of the ducts 12 and 14 as mentioned above. The ducts shown are corrugated ducts commercially available from General Technologies, Inc. of Stafford, Tex. Alternatively, other ducts may be used, in which case the specific size, shape, and internal contours of the bushing 32 and the seal 34 may be adjusted accordingly.

In accordance with one or more of the foregoing examples, the coupling sleeve 28 and the fitting 114 may be formed by blow molding. Blow molding tends to give better control over the outside diameter of the components, although perhaps not as good control over the inside diameter. However, variations may be accounted for by the compressible seal 34. Also, it will be appreciated that the nominal sizes of all of the components discussed herein may vary in accordance with the nominal sizes typically encountered in the field.

Referring now to FIG. 16, a duct 212 shown therein includes a first set of ribs 216 and a second set of ribs 217, and has no longitudinal ribs. A bushing 232 is lengthened in order to extend from a rib 216-3 to adjacent ribs 216-2 and 216-4. The bushing is sized to fit over the ribs 216 and 217.

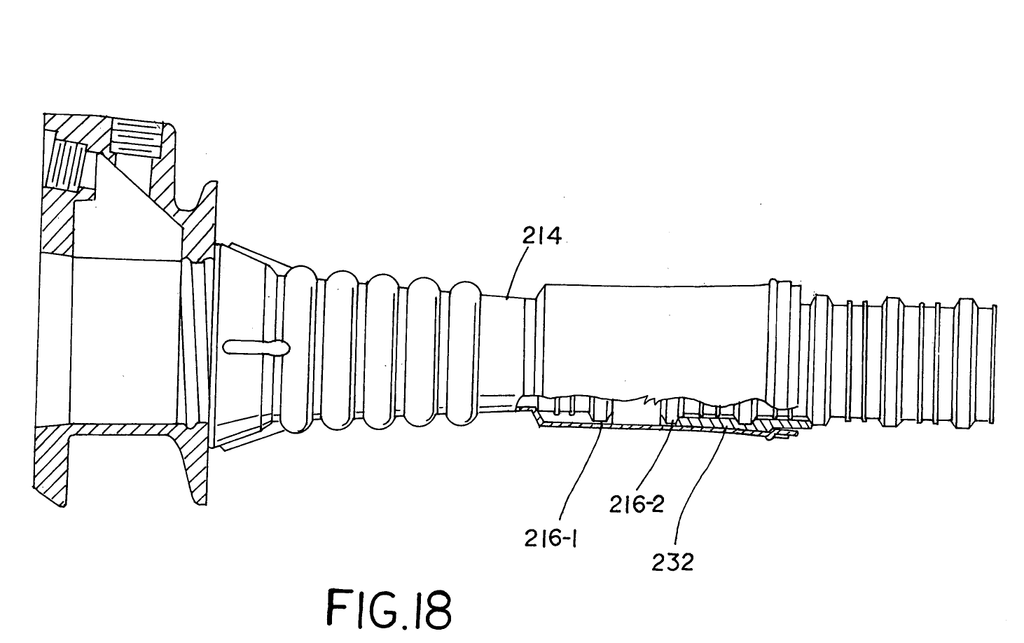

Referring now to FIG. 17, a duct 312 shown therein includes circumferential ribs 216 and longitudinal ribs 318. A bushing 332 is lengthened in order to extend from a rib 316-3 to adjacent ribs 316-2 and 316-4. The bushing has an internal recess sized to fit over the ribs 316-3.

As shown in FIG. 18, the bushing 232 of FIG. 16 is shown disposed within the end of a fitting 214, and a seal 234 is lengthened to extend between the ribs 216-1 and 216-2.

The preceding text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

What is claimed:

1. A duct assembly comprising:
a first duct and a second duct, each of the first and second ducts including a longitudinal axis and a plurality of circumferential ribs intermittently spaced along the longitudinal axis;
a sleeve having a first section and a second section, the first section sized to receive an end portion of the first duct and the second section sized to receive an end portion of the second duct;
a pair of bushings, each bushing sized to fit over the end portion of a corresponding one of the first and second ducts, each bushing sized to engage at least a first rib of the corresponding duct and to extend into a corresponding one of the first and second sections of the sleeve;
a pair of seals, each seal sized to fit within the sleeve and over one of the end portions of a corresponding one of the first and second ducts; and
an annular recess disposed adjacent each of the first end and the second end of the sleeve, each recess sized to engage a portion of the corresponding bushing to thereby secure the corresponding ducts in the sleeve.

2. The duct assembly of claim 1, wherein each seal is mounted adjacent a second rib of the corresponding duct.

3. The duct assembly of claim 1, wherein each seal is sized to fit between adjacent circumferential ribs.

4. The duct assembly of claim 1, wherein each seal is formed of a resilient material.

5. The duct assembly of claim 4, wherein the resilient material is closed cell EPDM.

6. The duct assembly of claim 1, wherein each bushing includes an internal recess sized to fit over the first rib.

7. The duct assembly of claim 6, wherein each bushing has a length sized to abut adjacent ribs.

8. The duct assembly of claim 7, wherein each bushing includes angled ends.

9. The duct assembly of claim 1, wherein each bushing includes an outer end and an external recess disposed adjacent the outer end, the external recess located to generally underlie and engage the recess on each of the first and second ends of the sleeve.

10. The duct assembly of claim 1, wherein each seal is sized to be disposed about the corresponding duct and between adjacent circumferential ribs.

11. The duct assembly of claim 1, wherein each recess on the sleeve is adapted to receive a tie to enable the first end and the second end of the sleeve to be secured to the first duct and the second duct, respectively.

12. The duct assembly of claim 11, wherein each duct includes a longitudinal rib, and wherein the each bushing includes a longitudinal cutout positioned to overlie the longitudinal rib.

13. The duct assembly of claim 1, wherein the bushing comprises two identical pieces.

14. The duct assembly of claim 11, wherein each duct includes a longitudinal rib, and wherein the each bushing includes a longitudinal cutout positioned to overlie the longitudinal rib.

15. The duct assembly of claim 14, wherein each bushing comprises a pair of identical bushing pieces, and wherein each bushing piece is sized to fit between adjacent longitudinal ribs.

16. The duct assembly of claim 15, wherein each bushing piece is includes a sloped outer surface.

17. An assembly for coupling a duct to a fitting, the fitting having a flared end and the duct having a plurality of longitudinally spaced circumferential ribs and at least one longitudinal rib, the assembly comprising:
a bushing, the bushing sized to fit over the duct and to extend into the flared end of the fitting;
the bushing having an internal recess sized to engage a first one of the circumferential ribs of the duct;
the bushing having an external recess; and
the external recess of the bushing sized and positioned to engage an inner portion of the flared end to secure the duct to the fitting.

18. The assembly of claim 17, wherein the internal circumferential recess of the bushing is sized in shaped to correspond to an outer contour of the first circumferential rib.

19. The assembly of claim 17, wherein the bushing includes a first section sized to extend to and abut an adjacent circumferential rib.

20. The assembly of claim 19, wherein the bushing includes a second section sized to extend to and abut another adjacent circumferential rib.

21. The assembly of claim 17, wherein the bushing is sized to be disposed between a pair of adjacent circumferential ribs.

22. The assembly of claim 17, wherein the bushing includes a longitudinal cutout sized to receive the longitudinal rib of the duct.

23. The assembly of claim 22, wherein the bushing includes an internal recess sized to receive the circumferential rib.

24. The assembly of claim 17, including a seal sized to fit within the fitting and over the duct; and wherein the seal is formed of a resilient material and is shaped to overlie a portion of the duct.

25. The assembly of claim 24, wherein the resilient material is EPDM.

26. An assembly for coupling a duct to an anchor comprising:
a duct having a longitudinal axis and a plurality of circumferential ribs intermittently spaced along the longitudinal axis;
a fitting having a first end adapted for attachment to the anchor and a flared second end and having a circumferential recess disposed adjacent the flared second end;
a bushing, the bushing sized to fit over the duct and to extend into the flared end of the fitting;
the bushing having an internal circumferential recess sized to engage a first one of the circumferential ribs, the bushing also including an external circumferential recess;
a seal sized to fit within the fitting; and
a tie sized to extend around the external recess of the fitting in a position to generally overlie the external recess of the bushing and adapted to secure the duct to the fitting.

27. The assembly of claim 26, wherein the internal circumferential recess of the bushing is sized and shaped to correspond to an outer contour of the first circumferential rib, and wherein the seal is sized to fit between an adjacent pair of circumferential ribs.

28. The assembly of claim 26, wherein the bushing includes a first section sized to extend to and abut an adjacent circumferential rib.

29. The assembly of claim 28, wherein the bushing includes a second section sized to extend to and abut another circumferential rib.

30. The assembly of claim 26, wherein the duct includes a plurality of longitudinal ribs, and wherein the bushing is sized to fit between adjacent longitudinal ribs.
